(19) United States
(12) Patent Application Publication
(10) Pub. No.: US 2003/0116959 A1
(43) Pub. Date: Jun. 26, 2003

(54) Encrypted mail envelope-identitiy

(76) Inventor: George Calvin Turner, Springfield, VA (US)

Correspondence Address: GEORGE C. TURNER, 6813 HACKBERRY ST., SPRINGFIELD, VA, 22150, US

(21) Appl. No.: 10/281,186

(22) Filed: Oct. 28, 2002

Related U.S. Application Data
(60) Provisional application No. 60/330,667, filed on Oct. 26, 2001.

(51) Int. Cl. B42D 15/00

(52) U.S. Cl. 283/116

(57) ABSTRACT

The present invention is to establish capabilities to identify and verify each sender of a mailed item(s) through the use of Encrypted Identity Envelopes. The use of the envelopes will improve the security of the United States Postal System and they will also provide a feeling of calm to individuals working with and receiving mail, and the encrypted envelopes will provide a basis to establishing a National Tracking System of Individuals. Each envelope will have a scannable personal identification block(s); the envelope may be in the form of a pre-identity stamped envelope or an identity stamp may be glued or “stamped” on. Additional personal information such as photo, finger prints (two or more fingers in case of accidents), DNA data (optional), iris identification, and other sources of personal identification as technologies become available and perfected may also be included in the identity blocks.

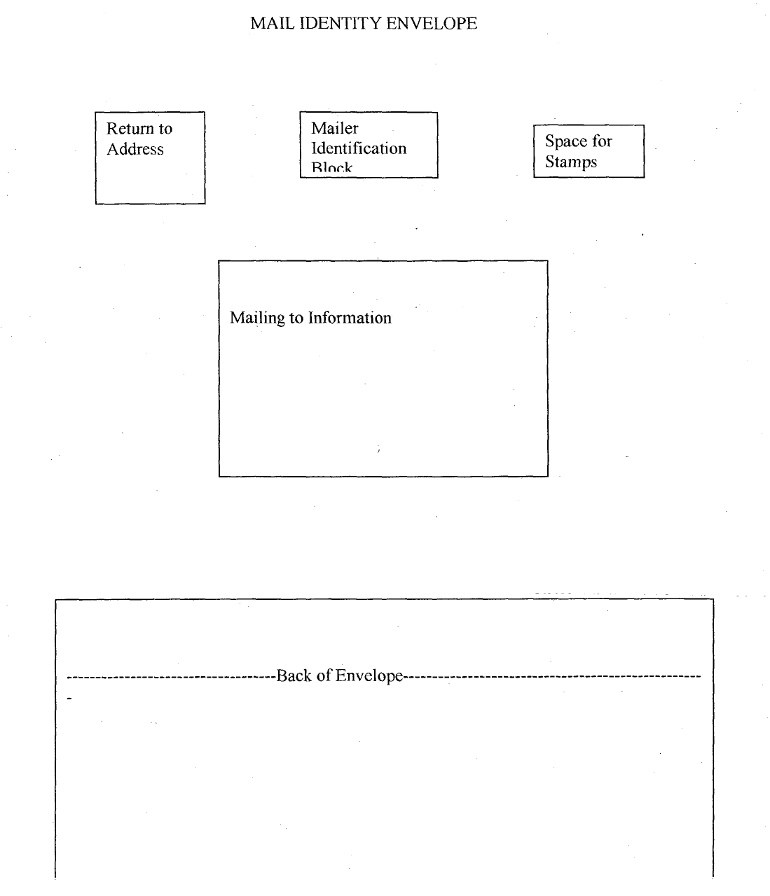

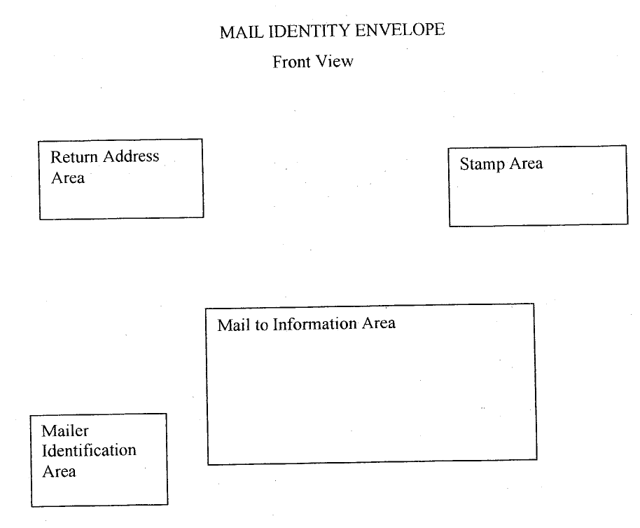

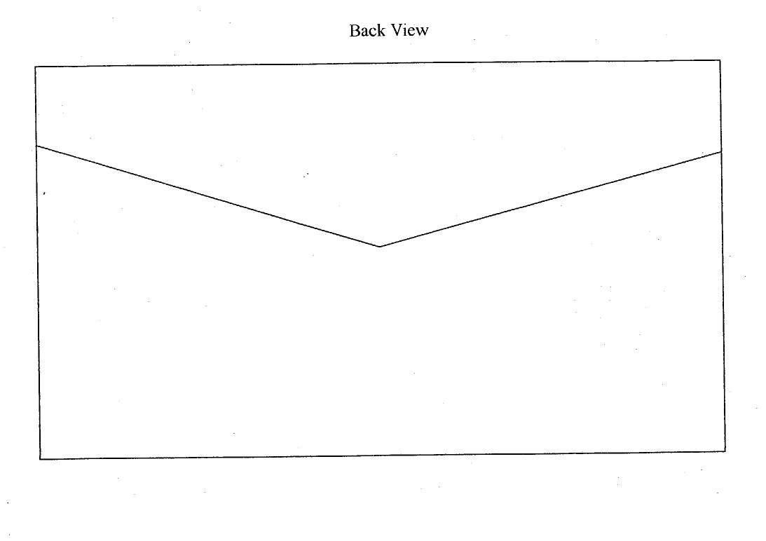

### PURPOSE OF IDENTIFICATION BLOCK(S)

The identification blocks will permit identification of each sender. It (or they) will be scanned in conjunction with the stamp verification process. Any letter, package, or mailed item not containing proper identification can be returned to the mailer or destroyed, or processed separately from verifiable mail.

### Mail Identity Envelope/Label/Package Mail Container

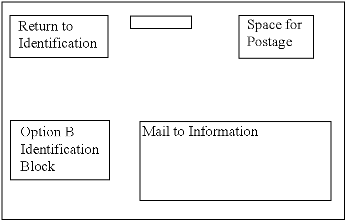

Identification Blocks (A and B and A or B) may consist of:

Finger Print

Photo-print/digital imaging/computer generated

DNA script (optional

Eye Imaging Identification Script/Label

Digital Imaging Label/Script

Type Paper

Current paper supplies use in the Postal System

Finger Print

Identification block(s) will permit finger printing of each mailer. The Postal Service will scan each letter for a finger print and the postage. Mail without proper identification will be returned to the sender, destroyed, or reprocessed through a cleansing or sterility process.

The Finger Print Block will consist of current finger printing technology.

Photo Identification

Computer Generated photo will be on file with the Postal Service. The identifier block will contain computer codes that will permit generating a photo and address of the sender.

A physical photo of the mailer may also be an option, which may be copied into the envelope or stamp.

Eye Imaging

Identification Block will contain eye imaging identification capabilities.

DNA Identification

1. I, George Calvin turner claim that the Postage Identity encrypted Envelope is intended to provide a tracking mechanism to identify senders of items through the Postal System.
To implement tracking capabilities, the encrypted envelopes will contain personal information on each purchaser of encrypted envelopes. The information collected and maintained on file may include all or partial data such as: name, address (current and previous), social security number, date of birth, finger prints (more than one on each hand in case of accidents), photo-digital, DNA data (optional), eye (iris) identification, e-mail address (s), and/or next of kin and/or contact person, and/or family members.
